(19) United States
(12) Patent Application Publication
(10) Pub. No.: US 2010/0146223 A1
(43) Pub. Date: Jun. 10, 2010

(54) Apparatus and method for data management

(75) Inventors: Doo-Hyun KIM, Seoul (KR); Joon-Ho SONG, Hwaseong-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/457,640

(22) Filed: Jun. 17, 2009

(30) Foreign Application Priority Data
Dec. 9, 2008 (KR) 10-2008-0124688

(51) Int. Cl. G06F 12/00; G06F 12/06

(52) U.S. Cl. 711/154; 711/E12.078; 711/200

(57) ABSTRACT

Provided is a data processing method that may transmit, from a host unit including at least one host to a tiling unit, an input parameter and first data, tile the first data using a predetermined block interleaving scheme to convert the first data to second data, and store the converted second data in a memory unit. The data processing method may transmit, from a host unit including at least one host to an inverse tiling unit, an input parameter and a request signal for first data, extract second data corresponding to the request signal from the memory unit to store at least one second data that is tiled using a predetermined block interleaving scheme, and may transmit, to the host unit, the first data that is converted by inverse tiling the second data. Here, the first data may be in a data structure of a sequential scanning scheme.

### CROSS-REFERENCE TO RELATED APPLICATIONS

This application claims the benefit of Korean Patent Application No. 10-2008-0124688, filed on Dec. 9, 2008, in the Korean Intellectual Property Office, the disclosure of which is incorporated herein by reference.

### BACKGROUND

1. Field

One or more embodiments relate to an optimization of a memory access that is required at a block-based codec in order to decrease data transmission latency, and more particularly, to a method and apparatus for processing data that may tile data of a sequential scanning scheme for high-speed data processing to thereby provide blocked data.

2. Description of the Related Art

Currently, with the development of multimedia technologies, various content having large capacity is being provided to users using various types of schemes.

In a content providing service, when processing a motion picture in association with a video data codec, a memory access amount may be excessive due to the large amount of image data. Accordingly, various types of research is ongoing with respect to motion picture technology. When the size of an image is small, a real-time process may be performed for the image. However, as more users demand higher quality images, the size of the images may also increase. Accordingly, memory access becomes the most significant issue in motion picture processing.

In particular, a dynamic random access memory (DRAM) to store a large capacity of image data may be assigned with an address due to a physical characteristic. A predetermined latency may occur until data is read or written. The latency may vary depending on the type of the DRAM, the manufacturer thereof, the input frequency, and the like. In view of a system, a latency of more than a predetermined cycle may be required.

The latency may function as a large load when accessing the large capacity of data. Generally, since the latency uses a burst access, it is possible to access adjacent data simultaneously and to decrease an initial latency.

However, although the burst access is applied, when accessing new data, for example, when a single burst operation is completed, when an access row is changed, and the like, the initial latency may be required.

Accordingly, in a block unit access of a video codec, an amount of adjacent data may be limited. Thus, a latency may occur every time the access row is changed.

### SUMMARY

According to an aspect of one or more embodiments, an apparatus for processing data may be provided. The apparatus may include a host unit comprising at least one host to transmit an input parameter and first data to a tiling unit, the tiling unit to tile the first data using a predetermined block interleaving scheme and to convert the tiled first data to second data, and a memory unit to store the converted second data. The first data may be in a data structure of a sequential scanning scheme.

Also, the data processing apparatus may further include a system bus to transfer the input parameter, the first data, and the second data that are transmitted and received between the host unit and the memory unit.

Also, the tiling unit may include a memory address calculation unit to calculate a memory address value of the first data according to the input parameter, to generate a tiled block, and to access the first data based on a block unit; and a data realignment unit to tile the first data to correspond to the block unit using a YUV interleaving scheme and to convert the first data to the second data.

According to another aspect of one or more embodiments, an apparatus for processing data may be provided. The apparatus may include a host unit including at least one host to transmit an input parameter and a request signal for first data to an inverse tiling unit, a memory unit to store at least one second data that is tiled using a predetermined block interleaving scheme, and the inverse tiling unit to extract, from the memory unit, second data corresponding to the request signal and to transmit, to the host unit, the first data that is converted by inverse tiling the extracted second data.

Also, the data processing apparatus may further include a system bus to transfer the input parameter, the request signal, the first data, and the second data that are transmitted and received between the host unit and the memory unit.

Also, the inverse tiling unit may include a memory address calculation unit to calculate a memory address value of the first data according to the input parameter, to generate a tiled block, and to access the first data based on a block unit; and a data realignment unit to extract the second data from the memory unit, to inverse tile the extracted second data to correspond to the block unit using a YUV interleaving scheme, and to convert the second data to the first data.

According to still another aspect of one or more embodiments, there may be provided a method of processing data, the method including: transmitting, from a host unit comprising at least one host to a tiling unit, an input parameter and first data that is in a data structure of a sequential scanning scheme; tiling the first data using a predetermined block interleaving scheme to convert the first data to second data; and storing the converted second data in a memory unit.

In this instance, the converting the first data to the second data may include: calculating a memory address value of the first data according to the input parameter to generate a tiled block and to access the first data based on a block unit; and tiling the first data to correspond to the block unit using a YUV interleaving scheme to convert the first data to the second data.

According to yet another aspect of one or more embodiments, a method of processing data may be provided. The method may include transmitting, from a host unit comprising at least one host to an inverse tiling unit, an input parameter and a request signal for first data that is in a data structure of a sequential scanning scheme, maintaining a memory unit to store at least one second data that is tiled using a predetermined block interleaving scheme, and extracting, from the memory unit, second data corresponding to the request signal to transmit, to the host unit, the first data that is converted by inverse tiling the extracted second data.

In this instance, the transmitting of the first data may include calculating a memory address value of the first data according to the input parameter to generate a tiled block and to access the first data based on a block unit; and extracting the second data from the memory unit to inverse tile the extracted second data to correspond to the block unit using a YUV interleaving scheme, and to convert the second data to the first data.

Additional aspects, features, and/or advantages of embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram illustrating a configuration of a data processing apparatus according to an embodiment;

FIG. 2 is a block diagram illustrating a configuration of a data processing apparatus according to another embodiment;

FIG. 3 illustrates a tiled memory structure according to an embodiment;

FIG. 4 illustrates a configuration of a tiling unit of FIGS. 1 and 2;

FIG. 5 illustrates an example of an input/output data structure of the data processing apparatus of FIGS. 1 and 2;

FIG. 6 is a block diagram illustrating a configuration of an inverse tiling unit of FIGS. 1 and 2;

FIG. 7 illustrates an example of an input/output data structure of the data processing apparatus of FIGS. 1 and 2;

FIG. 8 is a flowchart illustrating a method of processing data according to an embodiment; and

FIG. 9 is a flowchart illustrating a method of processing data according to another embodiment.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

When it is determined detailed description related to a related known function or configuration they may make the purpose of the present disclosure unnecessarily ambiguous in describing the embodiments, the detailed description will be omitted here. Also, terms used herein are defined to appropriately describe the embodiments and thus may be changed depending on a user, the intent of an operator, or custom. Accordingly, the terms must be defined based on the following overall description of this specification.

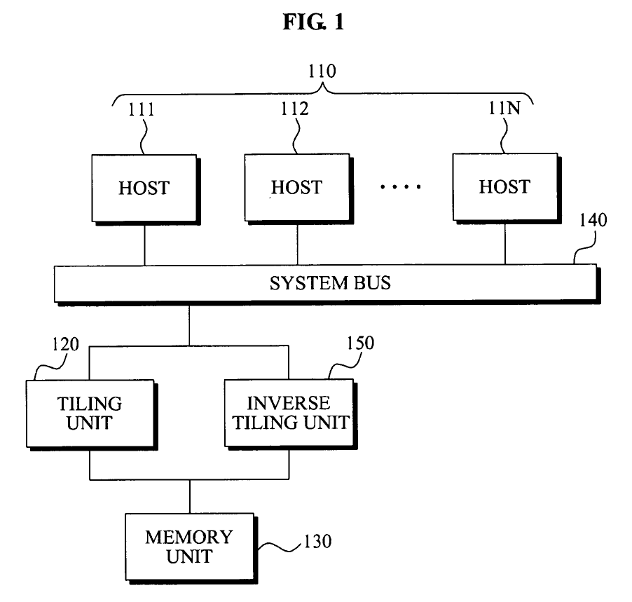

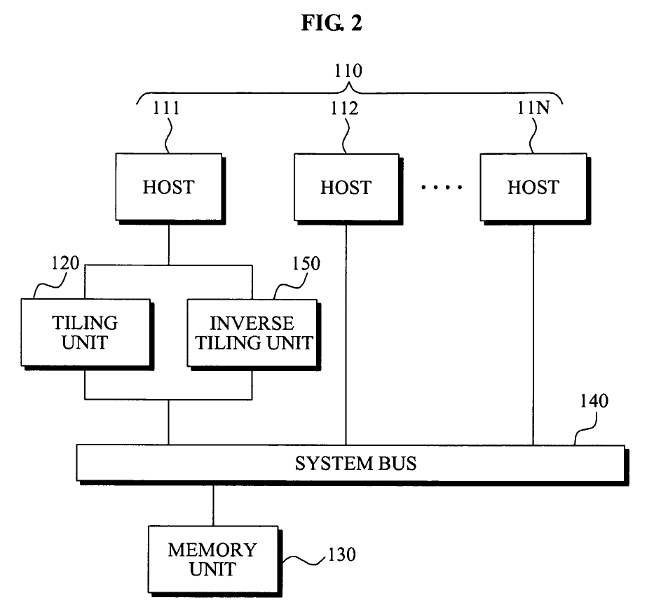

FIG. 1 is a block diagram illustrating a configuration of a data processing apparatus according to an embodiment, and FIG. 2 is a block diagram illustrating a configuration of a data processing apparatus according to another embodiment.

According to embodiments, the data processing apparatus may perform a different operation depending on a tiling unit 120 or an inverse tiling unit 150 included in the data processing apparatus. However, as shown in FIGS. 1 and 2, the tiling unit 120 and the inverse tiling unit 150 may be separately provided in the data processing apparatus. Alternatively, the tiling unit 120 and the inverse tiling unit 150 may be configured into a single module.

For ease of description, it is assumed herein that the tiling unit 120 and the inverse tiling unit 150 are provided separately. Hereinafter, embodiments of the tiling unit 120 and the inverse tiling unit 150 will be described in greater detail.

Initially, the data processing apparatus including the tiling unit 120 according to an embodiment will be described with reference to FIGS. 1 through 5.

A host unit 110 may include at least one host, for example, hosts 111, 112, . . . , 11N. The host unit 110 may transmit an input parameter and first data to the tiling unit 150. The first data may be in a data structure of a sequential scanning scheme.

The tiling unit 120 may tile the first data using a predetermined block interleaving scheme to convert the first data to second data.

Through the above process, the second data may be adjacent to information in a 4×6 block unit. Accordingly, in the case of a data access based on a block unit, it is possible to decrease a latency that may occur based on a row unit.

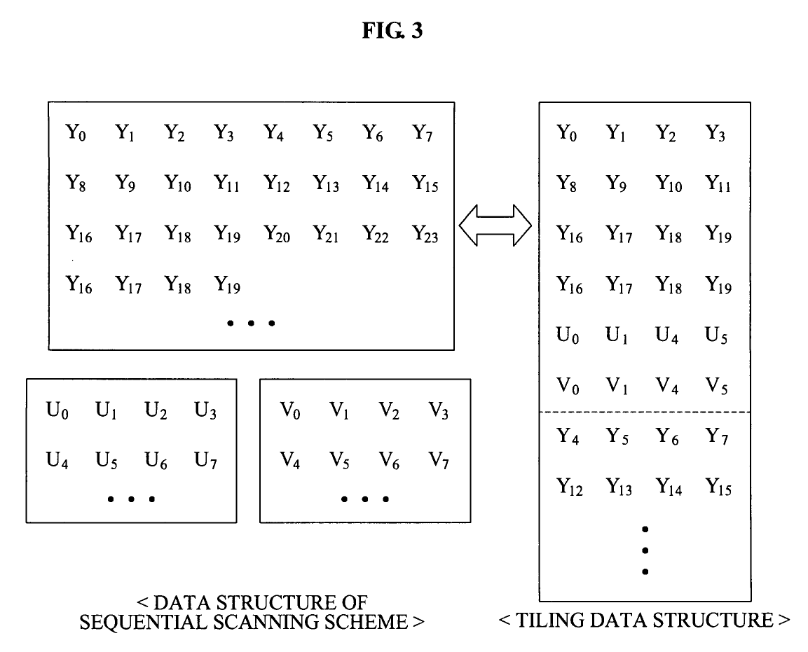

FIG. 3 illustrates a tiled memory structure according to an embodiment.

For example, as shown in FIG. 3, first data that is in a data structure of a sequential scanning scheme may be tiled using a 4×4 YUV interleaving scheme to thereby be converted to second data.

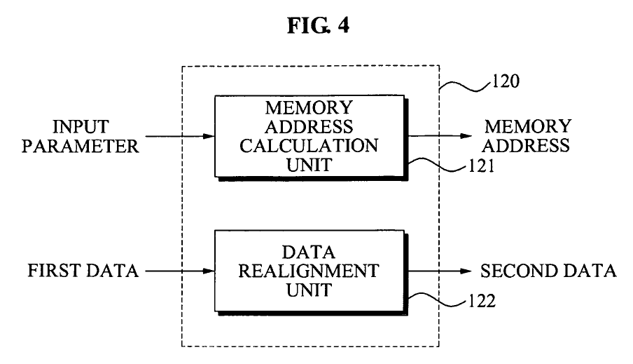

FIG. 4 illustrates a configuration of the tiling unit 120 shown in FIGS. 1 and 2.

As shown in FIG. 4, the tiling unit 120 may include a memory address calculation unit 121 and a data realignment unit 122.

The memory address calculation unit 121 may calculate a memory address value of the first data according to the input parameter, generate a tiled block, and access the first data based on a block unit.

The data realignment unit 122 may tile the first data to correspond to the block unit using a YUV interleaving scheme and may convert the first data to the second data.

A memory unit 130 of FIGS. 1 and 2 may store the converted second data.

Here, a Y component may be a luminance component of the first data, and a UV component may be a color component of the first data. In this case, the data realignment unit 122 may tile the UV component according to a predetermined tiling ratio, based on the Y component, to thereby convert the first data to the second data.

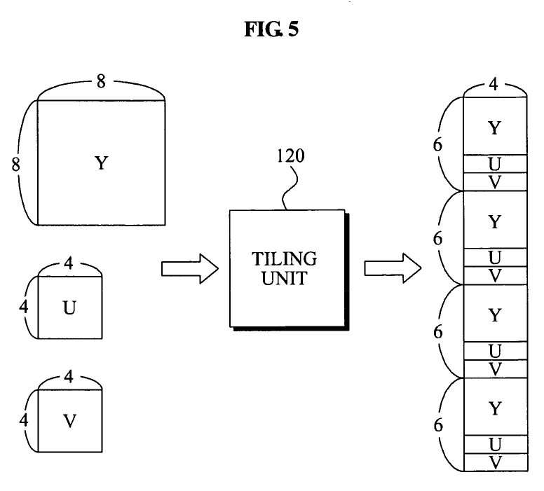

FIG. 5 illustrates an example of an input/output data structure of the data processing apparatus shown in FIGS. 1 and 2.

For example, when a Y component of a host side is a reference as shown in FIG. 5, the host unit 110 may request the memory unit 130 to write first data that is aligned based on a 4×4 block unit. Here, the Y component may request a UV component based on a 4:2:0 format for data that are aligned based on a 2×2 block unit. As shown in FIG. 5, when the Y component is an 8×8 block, the data realignment unit 122 may convert the aligned first data to second data that is aligned using a 4×6 YUV interleaving block scheme to thereby write the converted second data in the memory unit 130.

In this instance, the data processing apparatus may transfer, via a system bus 140, the input parameter, the first data, and the second data that are transmitted and received between the host unit 110 and the memory unit 130.

As shown in FIGS. 1 and 2, the data processing apparatus according to embodiments may generally be constructed using two schemes.

For example, when all the hosts 111, 112, . . . , 11N, included in the host unit 110, have the same memory structure, that is, when the first data transmitted from the hosts 111, 112, . . . , 11N have the same structure, the tiling unit 120 may be provided between the memory unit 130 and the system bus 140 as shown in FIG. 1.

As another example, when a particular host, for example, only the host 111, uses a block-based tiling structure, that is, when first data transmitted from the particular host 111 is in a data structure corresponding to the particular host 111 that transmits the first data, the tiling unit 120 may be provided between the host 111 of the host unit 110 and the system bus 140.

Hereinafter, the data processing apparatus that includes the tiling unit 150 according to another embodiment will be described with reference to FIGS. 1 through 3, and FIGS. 6 and 7.

The host unit 110 may transmit, to the inverse tiling unit 150, an input parameter and a request signal for first data. The first data may be in a data structure of a sequential scanning scheme.

The memory unit 130 may store at least one second data that is tiled using a predetermined block interleaving scheme.

The inverse tiling unit 150 may extract, from the memory unit 130, second data corresponding to the request signal and transmit, to the host unit 110, the first data that is converted by inverse tiling the extracted second data.

In this instance, the system bus 140 may transfer the input parameter, the request signal, the first data, and the second data that are transmitted and received between the host unit 110 and the memory unit 130.

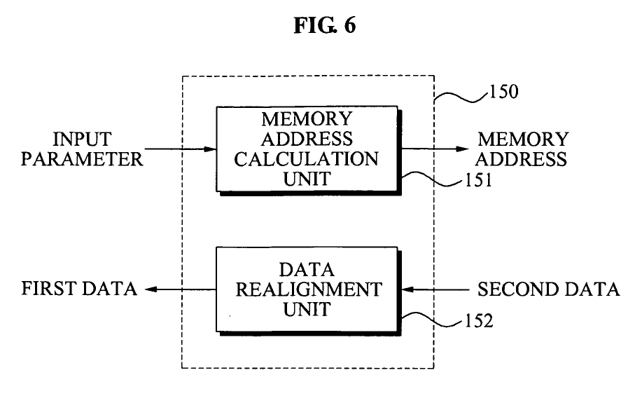

FIG. 6 is a block diagram illustrating a configuration of the inverse tiling unit 150 shown in FIGS. 1 and 2.

As shown in FIG. 6, the inverse tiling unit 150 may include a memory address calculation unit 151 and a data realignment unit 152.

The memory address calculation unit 151 may calculate a memory address value of the first data according to the input parameter, and thereby generate a tiled block, and access the first data based on a block unit.

The data realignment unit 152 may extract the second data from the memory unit 130, and thereby inverse tile the extracted second data to correspond to the block unit using a YUV interleaving scheme, and convert the second data to the first data.

In this instance, a Y component may be a luminance component of the first data, and a UV component may be a color component of the first data.

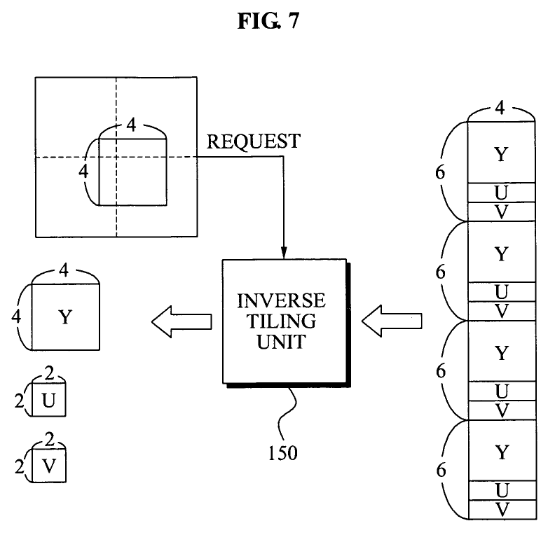

FIG. 7 illustrates an example of an input/output data structure of the data processing apparatus shown in FIGS. 1 and 2.

For example, when a Y component is a reference as shown in FIG. 7, the data processing apparatus may read, from the memory unit 130, a 4×4 block that is provided in a predetermined location.

Referring to FIG. 7, the host unit 110 is requesting the memory unit 130 to read a block that is not aligned based on a 4×4 block unit. In this case, second data is constructed to be adjacent to each other based on a 4×6 block unit in the memory unit 130. Accordingly, all the blocks that are overlapped with the 4×4 block may need to be extracted. However, according to another embodiment, since four blocks are overlapped, four 4×6 blocks may be extracted.

The data realignment unit 152 may convert the extracted second data to first data using a sequential scanning scheme to transfer the converted first data to the host unit 110.

In this instance, the data processing apparatus may also extract unnecessary data and thus may delete the unnecessary data using the data realignment unit 152. Since the YUV components are interleaved, the data realignment unit 152 may separate the second data into the Y component and the UV component to thereby transmit the second data to the host unit 110.

As shown in FIGS. 1 and 2, the data processing apparatus according to embodiments may generally be constructed using two schemes.

For example, when all the hosts 111, 112, . . . , 11N, included in the host unit 110, have the same memory structure, that is, when the first data transmitted from the hosts 111, 112, . . . , 11N have the same structure, the inverse tiling unit 150 may be provided between the memory unit 130 and the system bus 140 as shown in FIG. 1.

As another example, when a particular host, for example, only the host 111 uses a block-based tiling structure, that is, when first data transmitted from the particular host 111 is in a data structure corresponding to the particular host 111 that transmits the first data, the inverse tiling unit 150 may be provided between the host 111 of the host unit 110 and the system bus 140.

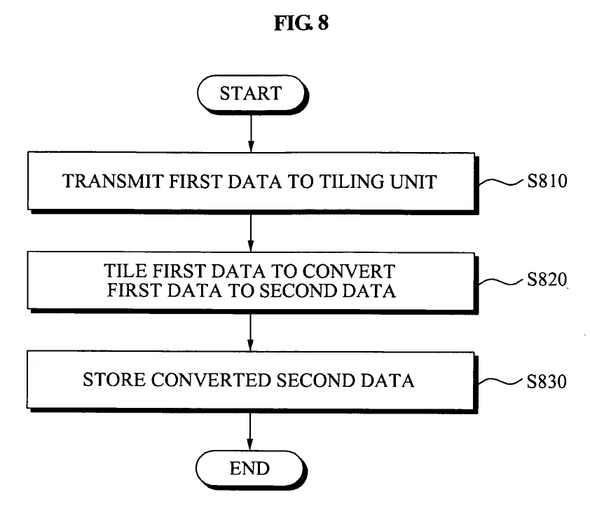

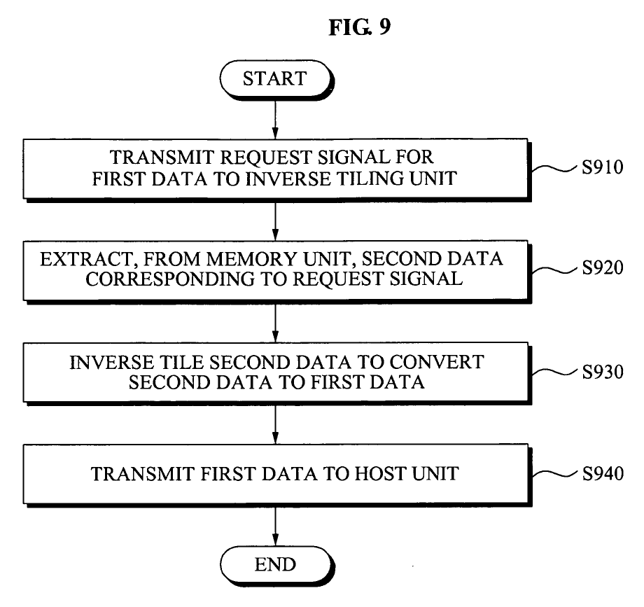

Hereinafter, a method of processing data according to embodiments will be described with reference to FIGS. 8 and 9.

The data processing method may be performed by the aforementioned data processing apparatus of FIGS. 1 and 2. Accordingly, further descriptions related thereto will be made.

Initially, the data processing method using the data processing apparatus to include the tiling unit 120 according to an embodiment will be described with reference to FIG. 8.

FIG. 8 is a flowchart illustrating a method of processing data according to an embodiment.

As shown in FIG. 8, in operation S810, the host unit 110 may transmit, to the tiling unit 120, an input parameter and first data that is in a data structure of a sequential scanning scheme.

In operation S820, the tiling unit 120 may tile the first data using a predetermined block interleaving scheme to convert the first data to second data by tiling the first data.

In this instance, the memory address calculation unit 121 of the tiling unit 120 may calculate a memory address value of the first data according to the input parameter, generate a tiled block, and access the first data based on a block unit.

Also, the data realignment unit 122 of the tiling unit 120 may tile the first data to correspond to the block unit using a YUV interleaving scheme and may convert the first data to the second data.

In operation S830, the memory unit 130 may store the converted second data.

The data processing apparatus may transfer, via the system bus 140, the input parameter, the first data, and the second data that are transmitted and received between the host unit 110 and the memory unit 130.

Hereinafter, the data processing method using the data processing apparatus to include the inverse tiling unit 150 according to another embodiment will be described with reference to FIG. 9.

FIG. 9 is a flowchart illustrating a method of processing data according to another embodiment.

As shown in FIG. 9, in operation S910, the host unit 110 may transmit an input parameter and a request signal for first data to the inverse tiling unit 150.

In this instance, the memory unit 130 may store at least one second data that is tiled using a predetermined block interleaving scheme.

In operation S920, the inverse tiling unit 150 may extract, from the memory unit 130, second data corresponding to the request signal.

In operation S930, the inverse tiling unit 150 may convert the extracted second data to first data using inverse tiling. In operation S940, the inverse tiling unit 150 may transmit the first data to the host unit 110.

For example, the memory address calculation unit 151 of the inverse tiling unit 150 may calculate a memory address value of the first data according to the input parameter, and thereby generate a tiled block and access the first data based on a block unit.

Also, the data realignment unit 152 of the inverse tiling unit 150 may extract second data from the memory unit 130, and thereby inverse tile the extracted second data to correspond to the block unit using a YUV interleaving scheme, and convert the second data to the first data.

The data processing apparatus according to another embodiment may transfer, via the system bus 140, the input parameter, the request signal, the first data, and the second data that are transmitted and received between the host unit 110 and the memory unit 130.

The data processing method according to the above-described embodiments may be recorded in computer-readable media including program instructions to implement various operations embodied by a computer. The media may also include, alone or in combination with the program instructions, data files, data structures, and the like. Examples of computer-readable media include: magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter. The described hardware devices may be configured to act as one or more software modules in order to perform the operations of the above-described embodiments, or vice versa. The software modules may be executed on any processor, general purpose computer, or special purpose computer including an apparatus for processing data.

As described above, a data processing apparatus according to embodiments may decrease a memory load in an application that frequently accesses block data, such as a video codec and the like.

Also, a data processing apparatus according to embodiment may perform tiling and YUV interleaving for a memory structure of a sequential scanning scheme, based on a predetermined block unit and thereby decrease a latency that may occur every time an access row is changed.

Although a few embodiments have been shown and described, it would be appreciated by those skilled in the art that changes may be made in these embodiments without departing from the principles and spirit of the disclosure, the scope of which is defined by the claims and their equivalents.

What is claimed is:

1. An apparatus for processing data, the apparatus comprising:
a host unit comprising at least one host to transmit an input parameter and first data to a tiling unit;
the tiling unit to tile the first data using a predetermined block interleaving scheme to convert the tiled first data to second data; and
a memory unit to store the converted second data.

2. The apparatus of claim 1, wherein the first data is in a data structure of a sequential scanning scheme.

3. The apparatus of claim 1, further comprising:
a system bus to transfer the input parameter, the first data, and the second data that are transmitted and received between the host unit and the memory unit.

4. The apparatus of claim 3, wherein, when the first data transmitted from each of the at least one host is in the same data structure, the tiling unit is provided between the system bus and the memory unit.

5. The apparatus of claim 3, wherein, when the first data transmitted from each of the at least one host is in a different data structure to correspond to each corresponding host, the tiling unit is provided between the corresponding host and the system bus.

6. The apparatus of claim 2, wherein the tiling unit comprises:
a memory address calculation unit to calculate a memory address value of the first data according to the input parameter, to generate a tiled block, and to access the first data based on a block unit; and
a data realignment unit to tile the first data to correspond to the block unit using a YUV interleaving scheme and to convert the first data to the second data.

7. The apparatus of claim 6, wherein a Y component is a luminance component of the first data, and a UV component is a color component of the first data.

8. The apparatus of claim 7, wherein the data realignment unit tiles the UV component according to a predetermined tiling ratio, based on the Y component, to thereby convert the first data to the second data.

9. An apparatus for processing data, the apparatus comprising:
a host unit comprising at least one host to transmit an input parameter and a request signal for first data to an inverse tiling unit;
a memory unit to store at least one second data that is tiled using a predetermined block interleaving scheme; and
the inverse tiling unit to extract, from the memory unit, second data corresponding to the request signal and to transmit, to the host unit, the first data that is converted by inverse tiling the extracted second data.

10. The apparatus of claim 9, wherein the first data is in a data structure of a sequential scanning scheme.

11. The apparatus of claim 9, further comprising:
a system bus to transfer the input parameter, the request signal, the first data, and the second data that are transmitted and received between the host unit and the memory unit.

12. The apparatus of claim 10, wherein the inverse tiling unit comprises:
a memory address calculation unit to calculate a memory address value of the first data according to the input parameter, to generate a tiled block, and to access the first data based on a block unit; and
a data realignment unit to extract the second data from the memory unit, to inverse tile the extracted second data to correspond to the block unit using a YUV interleaving scheme, and to convert the second data to the first data.

13. The apparatus of claim 12, wherein the data realignment unit separates the second data into a Y component and a UV component to thereby transmit the second data to the host unit.

14. A method of processing data, the method comprising:
transmitting, from a host unit comprising at least one host to a tiling unit, an input parameter and first data that is in a data structure of a sequential scanning scheme;
tiling the first data using a predetermined block interleaving scheme to convert the first data to second data; and
storing the converted second data in a memory unit.

15. The method of claim 14, further comprising:
transferring, via a system bus, the input parameter, the first data, and the second data that are transmitted and received between the host unit and the memory unit.

16. The method of claim 14, wherein the converting the first data to the second data comprises:
calculating a memory address value of the first data according to the input parameter to generate a tiled block and to access the first data based on a block unit; and
tiling the first data to correspond to the block unit using a YUV interleaving scheme to convert the first data to the second data.

17. A method of processing data, the method comprising:
transmitting, from a host unit comprising at least one host to an inverse tiling unit, an input parameter and a request signal for first data that is in a data structure of a sequential scanning scheme;
maintaining a memory unit to store at least one second data that is tiled using a predetermined block interleaving scheme; and
extracting, from the memory unit, second data corresponding to the request signal to transmit, to the host unit, the first data that is converted by inverse tiling the extracted second data.

18. The method of claim 17, further comprising:
transferring, via a system bus, the input parameter, the request signal, the first data, and the second data that are transmitted and received between the host unit and the memory unit.

19. The method of claim 17, wherein the transmitting of the first data comprises:
calculating a memory address value of the first data according to the input parameter to generate a tiled block and to access the first data based on a block unit; and
extracting the second data from the memory unit to inverse tile the extracted second data to correspond to the block unit using a YUV interleaving scheme, and to convert the second data to the first data.

20. A computer-readable recording medium storing computer readable code comprising instructions for implementing the method of claim 14.
